(19) United States
(12) Patent Application Publication
(10) Pub. No.: US 2008/0050574 A1
(43) Pub. Date: Feb. 28, 2008

(54) LOWER DENSITY, THERMOFORMABLE, SOUND ABSORBING POLYURETHANE FOAMS

(75) Inventors: David J. Lovell, Chadds Ford, PA (US); Chiu Y. Chan, Wilmington, DE (US); Scott E. Diaczun, Fort Wayne, IN (US)

Correspondence Address: CONNOLLY BOVE LODGE & HUTZ, LLP, P O BOX 2207, WILMINGTON, DE, 19899, US

(73) Assignee: Foamex L.P.

(21) Appl. No.: 11/858,387

(22) Filed: Sep. 20, 2007

Related U.S. Application Data
(62) Division of application No. 10/710,811, filed on Aug. 4, 2004.

(51) Int. Cl. B32B 5/18; C08G 18/00

(52) U.S. Cl. 428/304.4; 521/160

(57) ABSTRACT

Polyurethane foams formed under vacuum (below atmospheric pressure) conditions using primarily graft polyether polyols reacted with primarily toluene diisocyanate have lower densities (up to 1.3 lb/ft³), lower hardness (IFD₂₅ up to 50 lbs), and exhibit superb thermoformability and fire retardance while retaining good sound insulating characteristics. The foam-forming ingredients are mixed together and foamed under controlled pressures in the range 0.5 to 0.95 bar (absolute). Such foams taken alone, or in combination with a barrier layer to form a laminate, are thermoformed to create a sound insulator for a motor vehicle instrument panel.

### CROSS-REFERENCE TO RELATED APPLICATION

The present application is a division of application Ser. No. 10/710,811, filed Aug. 4, 2004.

This invention relates to lower density, flexible polyurethane foams that may be thermoformed and used in trim panels, instrument panels, interior panels and vehicle trim in the automotive, aircraft and railway industries.

### BACKGROUND OF THE INVENTION

Cellular polyurethane structures typically are prepared by generating a gas during polymerization of a liquid reaction mixture comprised of a polyester or polyether polyol, a polyisocyanate, a surfactant, catalyst and one or more blowing agents. The gas causes foaming of the reaction mixture to form the cellular structure. The surfactant stabilizes the structure. Mixtures of polyols, mixtures of isocyanates, mixtures of surfactants and mixtures of catalysts can also be used.

Once the foam-forming ingredients are mixed together, it is known that the foam may be formed under either elevated or reduced controlled pressure conditions. PCT Published Patent Application WO 93/09934 discloses methods for continuously producing slabs of urethane polymers under controlled pressure conditions. The foam-forming mixture of polyol, polyisocyanate, blowing agent and other additives is introduced continuously onto a moving conveyor in an enclosure with two sub-chambers. The foaming takes place at controlled pressure. Reaction gases are exhausted from the enclosure as necessary to maintain the desired operating pressure. The two sub-chambers, a saw, and air tight doors are operated in a manner that allows for continuous production of slabstock polyurethane foam.

Polyurethane foams with varying density and hardness may be formed. Hardness is typically measured as IFD (“indentation force deflections”) or CFD (“compression force deflection”). Specifically, IFD₂₅ is the force required to compress the foam to 25% of its original thickness or height. Tensile strength, tear strength, compression set, air permeability, fatigue resistance, sound transmission and energy absorbing characteristics may also be varied, as can many other properties. Specific foam characteristics depend upon the selection of the starting materials, the foaming process and conditions, and sometimes on the subsequent processing. Among other things, polyurethane foams are widely used in the passenger compartments and pilot cockpits of vehicles, including automobiles, trucks, aircraft and trains. Of particular relevance here are foams used in trim panels, instruments panels, door panels and headliners.

Foams for use as sound insulators for vehicle instrument panels ideally meet a set of conflicting criteria. Such foams preferably should have low density to meet continuing demands for weight reduction. Such foams also preferably should be soft such that they have good acoustic insulative properties. Yet, the foams should be thermoformable, which characteristic generally applies to foams with certain polyols, such as polymer polyols, that lead to greater foam hardness. The foams also must meet industry flammability requirements, which means that one or more flame retardants should be introduced into the foam forming mixture. Yet, flame retardants can adversely impact density and hardness properties. Various foams have been proposed as thermoformable foams for automotive applications. U.S. Pat. No. 4,741,951 discloses a method for forming thermoformable polyurethane foam articles from certain graft polyol dispersions. The resulting foams have densities greater than 1 pcf. Softness (IFD) and sound insulative properties are not disclosed.

U.S. Pat. No. 4,508,774 shows thermoformable polyurethane foams that are foamed from predominantly polyester polyols with aromatic polyisocyanates, such as MDI and polymeric MDI. The foams have densities from 15 kg/m³ to 40 kg/m³ (0.94 to 2.5 pcf), but the patent prefers densities from 20 kg/m³ to 38 kg/m³ (1.25 to 2.4 pcf).

U.S. Pat. No. 5,580,651 describes energy absorbing panels that include a resilient polyurethane foam core with a density in the range of 1.5 to 24 pcf and IFD₂₅ of less than 4000 lbs. The preferred IFD₂₅ range is from 150 to 4000 lbs. Such hardness does not meet sound insulative requirements for sound insulation panels for vehicle instrument panels. See also related U.S. Pat. No. 5,389,316.

U.S. Pat. No. 4,812,368 concerns planar molded or thermoformed polyurethane foam articles that are pre-treated with an aqueous isocyanate emulsion before thermoforming. The polyurethane foams may have densities of from 0.01 to 0.12 g/cm³ (0.62 to 7.5 pcf) before they are thermoformed. After the emulsion is applied and after the treated foam is thermoformed, the density ranges from 0.015 to 0.25 g/cm³ (0.94 to 15.6 pcf). The emulsion is believed necessary to achieve satisfactory thermoforming.

### SUMMARY OF THE INVENTION

According to the invention, a first aspect is a process for producing a thermoformable polyurethane foam-containing sound insulative laminate. In such process, a foam-forming composition is prepared with: (a) from 0 to 100% by weight of total polyol of a graft polyol having a functionality in the range from about 2.5 to 3.5 and a hydroxyl number in the range from about 20 to 70; (b) from 0 to 20% by weight of total polyol of a polyether polyol; (c) a polyisocyanate containing at least 80% by weight toluene diisocyanate and up to 20% by weight methylene diisocyanate; and (d) one or more blowing agents. The foam-forming composition is formed into a polyurethane foam under controlled pressure conditions from about 0.50 to about 0.95 bar (absolute). The density of the resulting polyurethane foam is 1.3 lb/ft³ or less, preferably 1.0 lb/ft³ or less. A layer of the polyurethane foam is then joined to a barrier layer to form the sound insulative laminate.

Preferably, the foam-forming composition includes one or more flame retardants, one or more catalysts, and one or more surfactants. The foam-forming composition optionally includes one or more additives, such as stabilizers, antimicrobial compounds, extender oils, dyes, pigments, and antistatic agents. The foam-forming composition also optionally includes from 0 to 20% by weight of total polyol of a polyester polyol.

Preferably, the blowing agent is water.

Preferably, the polyurethane foam has an IFD₂₅ of 50 lbs or below, and the polyurethane foam retains 70% compression set after thermoforming the laminate. The polyurethane foam is not pretreated with a thermoforming agent prior to thermoforming the laminate.

Preferably, the barrier layer is a filled EVA (ethylene vinyl acetate copolymer), filled asphalt, filled EPDM, filled PVC, filled rubber or bitumen board.

A second aspect is a sound insulator for an instrument panel made with a flame retardant, thermoformable, flexible, open celled polyurethane foam having a density of 1.0 lb/ft³ or less and an IFD₂₅ of 50 lbs. or less. Preferably, the foam is thermoformed under compression at a temperature in the range of about 300° F. to about 400° F. to form the sound insulator. The thermoformed foam retains a 70% compression set

Preferably, the foam is in the form of a sheet or slab, and a reinforcement, backing or decorative covering is applied to at least one surface of the foam sheet or slab. In one embodiment, the reinforcement, backing or decorative covering is applied to a surface of the foam sheet or slab as the foam is thermoformed. Most preferably, the foam sheet or slab has a thickness of from about 0.3 to 2.0 inches, preferably 0.5 to 1.2 inches, before it is thermoformed. Most preferably, the foam is not pre-treated with a thermoforming agent prior to thermoforming.

### DESCRIPTION OF THE DRAWINGS

FIG. 1 is an elevational view partially in cross section of a laminate for a thermoformable sound insulating panel; and

FIG. 2 is a perspective view of an automotive dash insulator formed with the laminate of FIG. 1.

### DETAILED DESCRIPTION OF THE INVENTION

Polyether polyols having a functionality of at least 2.0 are known to be suitable for producing flexible polyurethane foams. Polyether polyols used to prepare flexible polyurethane foams typically have molecular weights between 500 and 7000. One example of these conventional polyols is VORANOL 3010 from Dow Chemical, which has a hydroxyl (“OH”) number of 56 mg KOH/g and a functionality of 2.9, with an EO content of 8.5%. Another known polyether polyol is U-1000 from Bayer AG. U-1000 has a hydroxyl number of 168 and a functionality of 3.0, but 0% EO content. In addition, there is a group of higher EO polyols, typically used for high resiliency (HR) foam formulations. An example is VORANOL 4001 from Dow Chemical, which has an OH number of 31 and a functionality of 3.2, with an EO content of 15.5%.

The term “polyether polyol” includes linear and branched polyethers (having ether linkages) and containing at least two hydroxyl groups, and includes polyoxypropylene polyether polyol or mixed poly(oxyethylene/oxypropylene) polyether polyol. Preferred polyethers are the polyoxyalkylene polyols, particularly the linear and branched poly(oxyethylene) glycols, poly (oxypropylene) glycols and their copolymers.

Graft or modified polyether polyols are those polyether polyols having a polymer of ethylenically unsaturated monomers dispersed therein. Representative modified polyether polyols include polyoxypropylene polyether polyol into which is dispersed poly(styrene acrylonitrile) or polyurea, and poly(oxyethylene/oxypropylene) polyether polyols into which is dispersed poly(styrene acrylonitrile) or polyurea. Graft or modified polyether polyols contain dispersed polymeric solids. The solids increase hardness and mechanical strength of the resultant foam. Especially preferred graft polyols in this invention are VORANOL 3943, VORANOL 220-260 or ARCOL HS-100 from Bayer AG. Various other graft polyols are described in U.S. Pat. No. 4,741,951.

The “hydroxyl number” for a polyol is a measure of the amount of reactive hydroxyl groups available for reaction. The value is reported as the number of milligrams of potassium hydroxide equivalent to the hydroxyl groups found in one gram of the sample. “Functionality” of a polyol is defined as the average number of isocyanate reactive sites per molecule.

A preferred polyol for the invention has from 0 to 20% by weight conventional polyether polyol and 100 to 80% by weight graft polyol. The polyether polyol has a functionality from 1.8 to 3.3, preferably 1.8 to 2.3, and hydroxyl number from 20 to 70, preferably 28 to 36. The polyether polyol should contain from 0 to 25% EO and 0 to 88% primary OH groups. The graft polyol preferably has a functionality from 2.8 to 2.9 and an hydroxyl number from 25 to 35. It should contain styrene and acrylonitrile in a ratio of about 70 to 30.

The term “polyisocyanate” refers particularly to isocyanates that have previously been suggested for use in preparing polyurethane foams. “Polyisocyanates” include di- and polyisocyanates and prepolymers of polyols and polyisocyanates having excess isocyanate groups available to react with additional polyol. The amount of polyisocyanate employed is frequently expressed by the term “index” which refers to the actual amount of isocyanate required for reaction with all of the active hydrogen-containing compounds present in the reaction mixture multiplied by 100. For most foam applications, the isocyanate index is in the range between about 75 to 140. Preferably, the isocyanate index is in the range of 90 to 120.

Conventional polyisocyanates may be used in this invention. The preferred isocyanate is toluene diisocyanate (TDI), such as 2,4-toluene diisocyanate, and 2,6-toluene diisocyanate, and mixtures of 2,4-toluene diisocyanate with 2,6-toluene diisocyanate. A well known toluene diisocyanate is TD80, a commercially available blend of 80% of 2,4 toluene diisocyanate and 20% of 2,6 toluene diisocyanate. A mixture of methylene diisocyanate (MDI) and TDI may also be used. A commercially available MDT/TDI mixture is R-9423 from Huntsman. One methylene diisocyanate is S-7050 from Huntsman with a NCO content of 32.7% with over 50% 4,4′-methylene diisocyanate. Various other polyisocyanates are disclosed in U.S. Pat. No. 4,741,951. Preferably, TDI comprises a predominant portion of the polyisocyanate. If a mixture of TDI and MDT is used, the MDI is present from up to 20% by weight.

Polyisocyanates are typically used at a level of between 20 and 90 parts by weight per 100 parts of polyol, depending upon the polyol OH content and the water content of the formulation. In one embodiment of this invention, the isocyanate was used in an amount from about 40 to 60 parts by weight based on 100 parts polyol for a formulation using about 4 parts per hundred parts polyol of water, and had an isocyanate index from about 95 to 110.

Catalysts are used to control the relative rates of water-polyisocyanate (gas-forming) and polyol-polyisocyanate (gelling) reactions. The catalyst may be a single component, or in most cases a mixture of two or more compounds. Preferred catalysts for polyurethane foam production are organotin salts and tertiary amines. The amine catalysts are known to have a greater effect on the water-polyisocyanate reaction, whereas the organotin catalysts are known to have a greater effect on the polyol-polyisocyanate reaction. Total catalyst levels vary from 0 to 5.0 parts by weight per 100 parts polyol. The amount of catalyst used depends upon the formulation employed and the type of catalyst, as known to those skilled in the art. We have found that the following ranges of catalyst amounts are satisfactory: amine catalyst from 0 to 2 parts per 100 parts polyol; organotin catalyst from 0 to 0.5 parts per 100 parts polyol.

One or more surfactants are also employed in the foam-forming composition. The surfactants lower the bulk surface tension, promote nucleation of bubbles, stabilize the rising cellular structure and emulsify incompatible ingredients. The surfactants typically used in polyurethane foam applications are polysiloxane-polyoxyalkylene copolymers, which are generally used at levels between about 0.5 and 3 parts by weight per 100 parts polyol. In the present invention, from 0 to 2 parts by weight per 100 parts polyol of surfactant is preferred, and 1 part by weight per 100 parts polyol is most preferred.

A blowing agent may be included in the foam-forming composition. The most typical blowing agent is water that may be added in amounts from 2 to 5.8 parts per hundred parts polyol. Preferably, water as blowing agent is added in an amount suitable to achieve a desired foam density, and the amount may vary depending upon the operating pressure in the foaming chamber. We have found that at a pressure of 0.63 bar, about 4.2 parts per hundred parts polyol is an appropriate amount of water to achieve a foam with a density of about 1.0 pounds per cubic feet. Increasing the water amount generally decreases the resulting foam density. Optionally, carbon dioxide may be used as an auxiliary blowing agent.

To enhance flame retardancy, flame retardant additives are incorporated into the foam-forming composition in amounts from 0 to 20 parts by weight, preferably from 5 to 20 parts by weight, per hundred parts polyol. Higher amounts of flame retardants may also be used. Preferred flame retardants are Firemaster 550 and Antiblaze 100. Firemaster 550 is a proprietary blend from Great Lakes Chemical composed of a brominated aryl ester and an aromatic phosphate ester. Antiblaze 100 is a chlorinated phosphate ester from Albemarle Corporation. Both are considered “non-reactive” and do not become part of the polymer matrix upon foaming. Such flame retardants tend to soften foam. Low density foams frequently require higher levels of fire retardants to pass flammability requirements. Correspondingly higher water levels may be required to compensate for a higher fire retardant level.

Optionally, other additives may be incorporated into the foam-forming composition. The optional additives include, but are not limited to, stabilizers, antimicrobial compounds, extender oils, dyes, pigments, and antistatic agents. Such additives should not have a detrimental effect on the properties of the final polyurethane foam.

The foam-forming process may be carried out batch-wise, semi-continuously or continuously, as long as the pressure may be controlled and maintained below atmospheric pressure, preferably in the range of about 0.5 to 0.95 bar, most preferably 0.5 to 0.8 bar. The apparatus shown in WO93/09934 permits continuous foaming under controlled below atmospheric pressure conditions, and can be used to form slabstock foam on a large scale.

Before thermoforming, the polyurethane foam so produced should have a density of at most about 1 b/ft³ or pcf, and a moderate hardness, such as an IFD₂₅ of 50 lb. or below. Such foam should also be thermoformable and meet flammability requirements for material intended for installation in a vehicle passenger compartment or behind a vehicle control panel.

Sheets of polyurethane foam or a laminate composite containing such foam may be thermoformed in a number of different ways. In one method, the foam sheets are heated to their deformation temperature (i.e., between 300° F. and 400° F., preferably 325° F. to 375° F.) with the aid of infrared radiators, hot air ovens, contact hot plates or other heating means. The heated foam sheets are then placed into a forming tool or mold which is maintained either at room temperature or at a slightly elevated temperature (i.e., 70 to 150° F.) and formed therein with or without applied pressure. Preferably, pressure is applied to the mold to obtain the shape of the desired article. The mold may be made of various materials, such as wood, thermosetting plastic, gypsum or ceramics. After being held in the mold for as short as about 30 seconds to as long as about 300 seconds, the thermoformed article may be demolded immediately. Such thermoformed article should substantially hold its thermoformed shape after it has been demolded.

For some applications, the foam sheets can be provided with reinforcing, backing or decorative coverings at the same time the article is thermoformed by placing these desired reinforcements or coverings into the mold preferably with a heat-activated adhesive for bonding to the foam. It is also possible to incorporate reinforcement in the form of cloth, scrim, fibers or roving in the molded or thermoformed article by placing the reinforcement between two foam sheets which are then molded together in the manner described above. A wide range of reinforcing or decorative coverings are available, including textiles or glass, or metals, plastics, carbon or ceramics, foils, sheets, or particles. If desired, these coverings may be pigmented or printed.

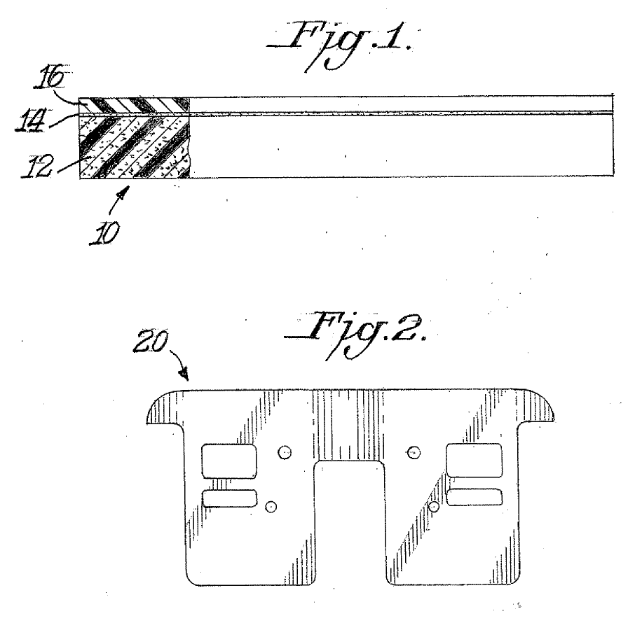

Referring to FIG. 1, a laminate 10 comprises a soft, low density polyurethane foam 12 adhered by an adhesive layer 14 to a higher density barrier layer 16. In a preferred embodiment, the adhesive in adhesive layer 14 is a polyolefin web adhesive. In other preferred embodiments, the barrier layer 16 is a material selected from the group consisting of filled EVA, filled PVC, filled EPDM, filled rubber, filled asphalt and bitumen board. The laminate may be thermoformed to create a dash insulator 20 such as shown in FIG. 2.

Thermoformed sound insulating assemblies according to the invention preferably have a high density, impermeable barrier layer bonded to a porous layer of soft, low density foam. Thermoforming allows for a good fit to the steel floor panel of a motor vehicle to increase acoustical performance. The high density barrier layer absorbs airborne noise, preventing transmission into the passenger cabin. The soft, low density foam layer decouples the structural vibrations from the high density layer.

The invention is further illustrated, but not limited by, the following examples.

### EXAMPLES

Foams were prepared batch-wise on a laboratory scale in a fixed head foam machine with the formulations listed in Table I. The water, isocyanates, polyols, surfactants, catalysts, flame retardant and other additives were poured from the fixed mixing head into a box positioned inside a chamber in which a vacuum was drawn. The pressure was maintained below atmospheric pressure by pumping air out of the chamber. Using a pressure regulator, the pressure was maintained at the operating pressure while the foam was allowed to rise. In the case of foams made at 1 Bar or atmospheric pressure, the boxes were located outside the chamber as pressure control was not necessary.

IFD₂₅ or “indentation force deflection” was determined in accord with a procedure similar to ASTM D 3574. In this case, foam was compressed by 25% of its original height and the force was reported after one minute. The foam samples were cut to a size 15″1×15″×4″ prior to testing.

Flammability was determined using the National Highway Traffic Safety Administration's Standard No. FMVSS 302. A test specimen is exposed to a flame for 15 seconds and burn rate was calculated by measuring the length the flame travels in millimeters divided by the time in seconds for the flame to travel that distance. The burn rate cannot exceed 102 mm per minute to pass FMVSS 302.

Thermoformability was tested by heating a foam specimen (3 inch×3 inch×½ inch) in an air-circulating oven set at 195° C. for a sufficient time (such as 5 to 7 minutes) to allow the specimen to reach equilibrium within the oven. The specimen was removed from the oven and immediately compressed to 0.100 inch thickness with a flat plate for two minutes at ambient conditions. The plate was then removed. After 30 minutes, the specimen thickness was measured and the amount of compression set was calculated. If the specimen recovered less than 35% of the compressed thickness (i.e., Recovery=100×((final thickness−0.100)−0.100)/0.100), thermoformability was deemed to be good. Thus, specimens remained at 0.135 inch thickness or less after removing the compression plate.

An alternative thermoformability test is set out in ASTM 3574. Under this 90% compression set test, a 2″×2″×1″ specimen is compressed to 90% of its original thickness and subjected to 70° C. for 22 hours. The specimens are allowed to recover for 30 minutes after removing from compression before re-measuring the thickness. Specimen that retain a 70% or greater compression set are deemed thermoformable and rated “good”. Specimen that retain a 90% or greater compression set are deemed thermoformable and rated “excellent”.

Sound transmission loss was tested according to the SA J1400 test standard. A test specimen is assembled to a metal substrate to simulate an in-vehicle assembly. This assembly is positioned in the opening between a sound transmitter room and a sound receiver room. Sound is generated in the transmitter room, and microphones positioned in the receiver room measure the amount of sound transmitted through the assembly.

Table I

TABLE I

| | | | | Ex. C | |
|---|---|---|---|---|---|
| | | Ex. A | Ex. B | com- | |
| Component | Type | compare | compare | pare | Ex. 1 |
| graft polyol | Elastoflex | 0 | 100 | 0 | 0 |
| | 21710 | | | | |
| graft polyol | Pluracol 1365 | 55 | 0 | 0 | 0 |
| graft polyol | Voranol 3943 | 0 | 0 | 50 | 90 |
| graft polyol | HL430 | 45 | 0 | 0 | 0 |
| polyol | Voranol 3136 | 0 | 0 | 50 | 0 |
| polyol | Voranol | 0 | 0 | 0 | 10 |
| | 220-260 | | | | |
| surfactant | Tegostab 8221 | 0.87 | 0 | 0.85 | 1.0 |
| surfactant | Q2-5160 | 0 | 1.08 | 0 | 0 |
| amine | ZF123 | 0.145 | 0 | 0.11 | 0.1 |
| catalyst | Stannous | 0.085 | 0 | 0.13 | 0.21 |
| | octoate | | | | |
| tin catalyst | T-12 | 0 | 0.016 | 0 | 0 |
| catalyst | TD33 | 0 | 0.49 | 0.13 | 0.1 |
| stabilizer | DEOA-LF | 0 | 0.68 | 0 | 0 |
| flame retard. | DE60F | 0 | 0 | 14 | 0 |
| flame retard. | Antiblaze 100 | 0 | 8.0 | 0 | 0 |
| flame retard. | Firemaster 550 | 0 | 0 | 0 | 17 |
| blowing | Water | 4.32 | 4.0 | 4.25 | 4.2 |
| agent | | | | | |
| isocyanate | Elastoflex 2120 | 0 | 94.84 | 0 | 0 |
| | (MDI) | | | | |
| isocyanate | TDI 80/20 | 56.64 | 0 | 54.84 | 51.40 |
| | Index | 113 | 123 | 115 | 105 |
| | Chamber | 750 | 1000 | 600 | 630 |
| | Pressure (mb) | | | | |
| | Density (pcf) | 1.0 | 2.0 | 0.9 | 1.0 |
| | IFD₂₅ | 72 | 65 | 27 | 42 |
| | (lbs) | | | | |
| | MVSS 302 | 58 | 85 | 170 | 33 |
| | (mm/min.). | | | | |
| | Thermo- | Excellent | Good | Fair | Good |
| | formable | | | | |
| | Sound insulator | Poor | Poor | Good | Good |

The polyols were obtained from the following suppliers: ELASTOFLEX 21710 and PLURACOL 1365 from BASF AG; and HL430, VORANOL 3943, 3136 and 220-260 from Dow Chemical. The surfactant TEGOSTAB 8221 was from DeGussa Goldschmidt and Q2-5160 was from Air Products and Chemicals. The tin catalysts T-12 and stannous octoate were from Air Products and Chemicals. The amine catalyst ZF123 and TD33, and the stabilizer DEOA-LF were from Huntsman. The isocyanate TDI 80/20 was from Dow Chemical. Antiblaze 100 was from Albemarle. Firemaster 550 was from Great Lakes Chemical.

The inventive foam of Example 1 best satisfies all criteria for a sound insulating foam for use in an insulating laminate behind a vehicle instrument panel. The foam has good thermoformability, and also passes the MVSS 302 flame retardancy standard. The foam has a low density of 1 pcf, yet has a sufficient softness, as measured by IFD₂₅ of 42 lbs, to reduce sound transmission.

In contrast, although thermoformable, the comparative Example A foam failed the flammability test and had a hardness greater than 50 lbs, meaning that such foam does not have desired acoustic properties. The comparative Example B foam was thermoformable, but had a density of 2 pcf and a hardness greater than 50 lbs, and that it did not have desired acoustic properties. Comparative Example C had a lower density and was sufficiently soft for desired acoustic properties, but was not sufficiently thermoformable.

The invention has been illustrated by detailed description and examples of the preferred embodiments. Various changes in form and detail will be within the skill of persons skilled in the art. Therefore, the invention must be measured by the claims and not by the description of the examples or the preferred embodiments.

We claim:

1. A process for producing a thermoformable polyurethane foam-containing sound insulative laminate, comprising:
(1) preparing a foam-forming composition from: (a) from 0 to 100% by weight of total polyol of a graft polyol having a functionality in the range from about 2.5 to 3.5 and a hydroxyl number in the range from about 20 to 70; (b) from 0 to 20% by weight of total polyol of a polyether polyol; (c) a polyisocyanate containing at least 80% by weight toluene diisocyanate and up to 20% by weight methylene diisocyanate; and (d) one or more blowing agents,
(2) forming the polyurethane foam from the foam-forming composition under controlled pressure conditions from about 0.50 to about 0.95 bar (absolute), wherein the density of the resulting polyurethane foam is 1.3 lb/ft³ or less; and
(3) thermoforming a layer of the polyurethane foam to a barrier layer to join said layers together to form the sound insulative laminate, wherein the barrier layer is a material selected from the group consisting of filled asphalt, filled EVA, filled EPDM, filled rubber, filled PVC, and bitumen board.

2. The process of claim 1, wherein the polyurethane foam has an IFD₂₅ of 50 lbs or below.

3. The process of claim 1, wherein the foam-forming composition includes (e) from 0 to 20% by weight of total polyol of a polyester polyol.

4. The process of claim 1, wherein the foam-forming composition includes (e) one or more additives selected from the group consisting of: stabilizers, antimicrobial compounds, extender oils, dyes, pigments, and antistatic agents.

5. The process of claim 1, wherein the blowing agent is water.

6. The process of claim 1, wherein the polyurethane foam retains a 70% compression set after thermoforming the laminate.

7. The process of claim 1, wherein the polyurethane foam is not pre-treated with a thermoforming agent prior to thermoforming the laminate.

8. A thermoformed article formed from the laminate of claim 1.

9. A sound insulator for an instrument panel, comprising:
a flame retardant, thermoformable, flexible, open celled polyurethane foam having a density of 1.0 lb/ft³ or less and an IFD₂₅ of 50 lbs. or less, wherein the foam is in the form of a sheet or slab, and
a reinforcement, backing or decorative covering applied to at least one surface of the foam sheet or slab to form a laminate.

10. The sound insulator of claim 9, wherein the reinforcement, backing or decorative covering is applied to a surface of the foam sheet or slab as the foam by thermoforming.

11. The sound insulator of claim 10, wherein the foam is thermoformed under compression at a temperature in the range of about 300° F. to about 400° F. to form the sound insulator.

12. The sound insulator of claim 11, wherein the thermoformed foam retains a 70% compression set.

13. The sound insulator of claim 10, wherein the foam is in the form of a sheet or slab that has a thickness of from about 0.3 to 2.0 inches before it is thermoformed.

14. The sound insulator of claim 10, wherein the foam is not pre-treated with a thermoforming agent prior to thermoforming.

15. The sound insulator of claim 9, wherein the reinforcement, backing or covering is formed of a material selected from the group consisting of: filled asphalt, filled EVA, filled EPDM, filled rubber, filled PVC, and bitumen board.

16. The sound insulator of claim 9, wherein the reinforcement, backing or covering is adhered to the foam with an adhesive prior to thermoforming.
